(19) United States
(12) Patent Application Publication
(10) Pub. No.: US 2014/0372735 A1
(43) Pub. Date: Dec. 18, 2014

(54) SOFTWARE CONTROLLED INSTRUCTION PREFETCH BUFFERING

(71) Applicants: Muhammmad Yasir Qadri, Wah Cantt (PK); Nadia Nawaz Qadri, Wah Cantt (PK); Klaus Dieter McDonald-Maier, Harwich (GB)

(72) Inventors: Muhammmad Yasir Qadri, Wah Cantt (PK); Nadia Nawaz Qadri, Wah Cantt (PK); Klaus Dieter McDonald-Maier, Harwich (GB)

(21) Appl. No.: 13/918,431

(22) Filed: Jun. 14, 2013

(51) Int. Cl. G06F 9/38

(52) U.S. Cl. CPC G06F 9/3804
USPC 712/237

(57) ABSTRACT

The invention relates to the method of prefetching instruction in micro-processor buffer under software controls.

### BACKGROUND OF THE INVENTION

This invention relates to the method of prefetching instructions in a micro-processor buffer under software control.

### BRIEF SUMMARY OF THE INVENTION

Cache memories have been widely used in microprocessors and microcontrollers (now on referred to as processor) for faster data transfer between the processor and main memory. Low end processors however do not employ cache for mainly two reasons. 1) The overhead of cache implementation in terms of energy and area is greater, and 2) as the cache performance primarily depends on number of hits, increasing data miss could cause processor to remain in stall mode for longer durations which in turn makes cache to become a liability than an advantage. Based on the facts discussed above a method of buffering instructions using software based prefetching is proposed which with minimum logic and power overhead could be employed in low-end processors for improving throughput. A preliminary search of the prior work in this field did not disclose any patents directly related to this invention but the following could be considered related:

U.S. Pat. No. 5,838,945: In which instruction and data prefetch method is described, where a prefetch instruction can control cache prefetching.

U.S. Pat. No. 4,713,755: In which a method of cache memory consistency control using software instructions is claimed.

U.S. Pat. No. 5,784,711: In which a method of data cache prefetching under the control of instruction cache is claimed.

U.S. Pat. No. 4,714,994: In which a method to control the instruction prefetch buffer array is claimed. The buffer could store the code for a number of instructions that have already been executed and those which are yet to be executed.

U.S. Pat. No. 4,775,927: In which a method and apparatus that enables an instruction prefetch buffer to distinguish between old prefetches that occurred before a branch and new prefetches which occurred after the branch in an instruction stream is claimed.

### BRIEF DESCRIPTION OF THE DRAWING

FIG. 1 depicts the timing diagram of Instruction Buffer Operation

FIG. 2 depicts the Instruction Buffer Architecture

### DETAILED DESCRIPTION OF THE INVENTION

The major difference between the proposed buffer and typical cache systems is its control that is completely done by software. During software design phase or code compilation, control words specifying exact location of the instructions are placed at the location one instruction ahead, so that during execution the instructions required in the next cycle could be fetched seamlessly.

Essential Features of the invention are a processor with cycle time greater than or equal to that of the associated data memory (i.e. time to perform a memory read or memory write). Whereas for the instruction memory the memory read cycle time (only) should be less than or equal to that of the processor.

An instruction memory capable of providing access to at least two locations in one cycle.

Addition of special control words (or instructions) before each instruction of the user code to help the system know in advance which data is to fetch next.

Important (but not Essential) Features include a software tool or compiler to automatically generate and insert the control words to the code and a software tool or an extension of the tool mentioned above; to keep track of available data buffer space and insert control words to replace data not needed.

The proposed embodiment contains a two buffer based instruction buffer area, where one buffer is to always serve as a default location if a branch is taken (called True) and the other if the branch is not taken (called False).

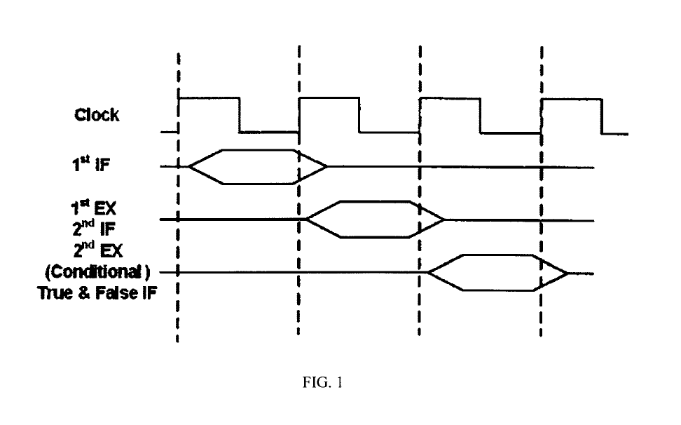

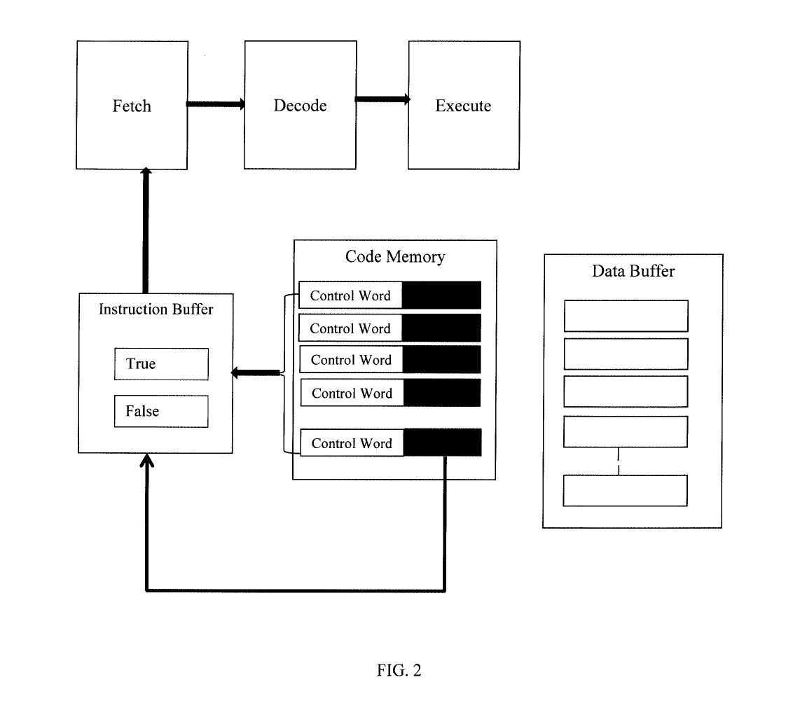

The instruction buffers may not have any source address associated with it. Although it could have a single bit tag to indicate the buffer as a default True or False. FIGS. 1 and 2 illustrate the operation of the instruction buffer. For instructions except branch, it is the same as of a typical two stage pipelined processor i.e. in the first cycle only one Instruction Fetch (IF) is performed, and in the following cycle the first instruction is executed and the next instruction is fetched. The operation without branch does not require any control word so it would be carried out uninterrupted until a branch occurs. If the subsequent instruction is a (FIG. 1) conditional branch, then two instructions are fetched at a time for true and false operations.

The address of these two instructions will be indicated by the preceding control words beforehand. These two instructions will then be held at fixed locations in the Instruction Buffer i.e. one location fixed for true and the other for false. If the branch is taken then the instruction from the true buffer location is executed, otherwise the instruction in the false buffer is executed. As any of the two buffers can be used as default location so that non-branch instructions get stored and executed from there. This type of buffer would accelerate the performance of the processor which in otherwise has to stall until the branch is resolved.

What is claimed is:

1. A method to prefetch instructions from memory to a buffer comprising a storage array wherein:
the said processor having memory fetch latency less than or equal to the processor's CPI;
the said array comprises multiple storage locations;
the said array is placed between the memory and the processor;
the said array has an addition of control words to the user code through compiler or other software;
the said control words are added to assist the said buffering mechanism to prefetch the next instructions;
the said control words are inserted in the code where a conditional/unconditional branch, jumps function call/return, or any other instruction that requires additional cycles to compute address and may result in halting the instruction pipeline;
the said buffer has locations specific to the instructions to be fetched if the conditional branch is taken and the other if the branch is not taken; and,
the said buffer uses a default location to prefetch the next instruction to be executed for unconditional branches, jumps, function call/return, or any other instruction that does not fit into the category of conditional branch.

2. The method of claim 1 wherein said prefetch buffer includes at least two storage locations where one set of locations allocated to the instructions to be fetched in case branch is taken and others in case if branch is not taken.

3. The method of claim 1 wherein the said processor has a two-stage pipeline.

4. The method of claim 3, wherein the said control words inserted comprise at minimum one instruction before the instruction that requires additional cycles to compute address of the data to be fetched and may result in halting the instruction pipeline.

5. The method of claim 3, wherein the said control words inserted in one instruction before the conditional/unconditional branch, jumps, function call/return, or any other instruction that requires additional cycles to compute address and may result in halting the instruction pipeline.

6. The method of claim 3, wherein the prefetch buffer having a location for the instruction that is to be fetched if the branch is taken and a location if the branch is not taken

7. The method of claim 6, wherein one of the locations designated is a default location.

8. The method of claim 7, wherein said default designation of the buffer is programmable or fixed.

9. The method of claim 8, whereas the default location is treated to supply instructions to the pipeline in case of non-conditional branch instructions.

10. The method of claim 9, wherein the prefetch buffer supplies the next instruction to be executed to the pipeline by the help of operand forwarding of the instruction currently in execution whose result will determine the address for the next instruction to be fetched.

11. The method of claim 9, wherein the method is extendable to any number of pipeline stages.
